(19) United States
(12) Patent Application Publication
(10) Pub. No.: US 2015/0029829 A1
(43) Pub. Date: Jan. 29, 2015

(54) Timepiece Comprising An Analog Display and a Digital Display

(71) Applicant: Daniel Spadini, Genève (CH)

(72) Inventor: Paolo Spadini, Geneve (CH)

(21) Appl. No.: 14/373,746

(22) PCT Filed: Jan. 23, 2013
(86) PCT No.: PCT/EP2013/051236

§ 371 Date: Jul. 22, 2014

(30) Foreign Application Priority Data
Jan. 23, 2012 (CH) 0095/12

(51) Int. Cl. G04C 17/00

(52) U.S. Cl. CPC G04C 17/0091
USPC 368/226; 368/228

(57) ABSTRACT

The present invention relates to a watch, comprising: a frame (1); a movement (2) mounted in said frame; a top crystal (3); an analog display system including a dial (4) combined with hands (5); and at least one digital display for displaying complementary information. The digital display includes a top functional element (6) extending under a peripheral strip (3a) of the crystal (3) so as to simulate at least part of a bezel.

The present invention relates to timepieces, in particular hybrid watches comprising digital display means and also an analog display with hands.

Dual-display watches, called hybrid watches, offer both the advantage of fast reading of the time by means of hands, and of a display of additional functions on the digital screen. It is for example known to display on the digital display information regarding date, second time zone, chronographic items, compass, altitude, temperature, lifetime of the battery, etc. A control member allows the user to bring about the display of an item of information and to select the desired item of information.

The digital screens employed in horology are often matrix screens or ones with segments based on liquid crystals. A polarizer is necessary on the surface of these screens so as to block the light reflected on a mirror at the rear of the screen, except the light polarized by the liquid crystal molecules activated by an electric field when a pixel or segment is switched on. The zones of the screen which are not switched on therefore appear as a dark surface consisting of a practically opaque polarizing plate. The switched-on zones consist of portions in which the light reflected by the mirror and polarized by the liquid crystal molecules succeeds in passing through the polarizing plate.

When the watch passes from a switched-on state to a switched-off or standby mode, a dark patch persists in the dial, whose dimensions correspond to the dimensions of the digital display. This dark area is difficult to integrate in an esthetic manner into the dial of a watch with hands. To avoid this patch, numerous manufacturers have forgone the possibility of placing the digital display into standby mode.

CH702862 describes a watch with a digital display occupying the whole of the surface under the watchglass.

GB2291723 describes a watch comprising a luminous diode for signaling the arrival of a message.

The luminous diode is disposed in an inclined portion of the upper face of the case, beyond the periphery of the watchglass. Although this diode only makes it possible to display a binary item of information (“message received” or “no message received”), its presence is detrimental to the appearance of the watch even when the diode is switched off.

FR2496289 describes a hybrid watch comprising an analog display as well as a digital display. The digital display is disposed in a substantially central opening made in the dial. This opening constitutes a dark patch which is detrimental to the esthetics of the dial when the digital display is switched on, and still more when it is switched off.

A polarizer can be pivoted above the digital display and the dial so as to render this display visible or invisible.

EP539333 describes a liquid-crystal matrix display device drilled with a hole intended for the passage of the spindles of the hands. The liquid-crystal display thus forms the dial of the watch behind the hands, thereby limiting the freedom of the designer to employ a dial of the color and of the look desired. Despite the presence of hands, such a watch is often perceived as a cheap watch because of the significant space occupied by the liquid-crystal display which always remains visible. Moreover, the manufacture of a liquid-crystal display of relatively large dimensions, drilled with a hole, is expensive. In general, these holes are drilled by laser, or laser guided in a water jet, this being a tricky extra operation, especially if the hole has a significant diameter. The row and column electrodes of the display must steer clear of this hole, this being difficult to achieve. Moreover, the edges of the hole must further be insulated and glued.

EP389411 describes another hybrid watch having an analog display and a digital display. This watch comprises a polarizer constituting the dial-forming plate. Various digital displays are distributed under the polarizer. This solution requires a dial formed of a polarizer, thereby constituting a significant esthetic constraint. Moreover, a thick polarizer is necessary in order to afford the dial sufficient mechanical rigidity. Moreover, the drilling of the hole or holes for the passage of the hand spindles is a tricky operation when a polarized glass dial is involved.

A similar solution is also described in JP58-115389 which relates to a watch exhibiting an analog display and a digital display in a zone peripheral to the zone dedicated to the analog display. A polarizer tied to the watchglass can be pivoted by way of a bezel or of a winding crown so as to render the digital display invisible. Again, the employing of a polarizer which covers and obscures the whole of the dial is esthetically very constraining. Moreover, the rotary arrangement of the polarizer increases the complexity of the watch.

US2005/0078560 (ETA SA Manufacture) describes an electronic wristwatch with a dial comprising a series of symbols disposed in an annular manner at the periphery. These symbols may for example consist of LEDs to display various items of information, such as olympic disciplines. The symbols being displayed at the level of the dial, that is to say visibly below the surface of the watchglass, they do not make it possible to simulate a bezel. They remain furthermore distinctly visible even when they are switched off.

An aim of the present invention is to propose a hybrid watch whose digital display does not impair the esthetics of the whole.

Another aim of the present invention is directed at providing a hybrid watch exhibiting an appearance similar to that of conventional analog watches furnished with a bezel.

Another aim of the present invention is to propose a hybrid watch which is simple and economical to manufacture.

These aims are attained with the aid of a watch comprising:
a case,
a movement mounted in said case,
a watchglass,
a dial;
hands,
at least one digital display comprising an upper functional element and one or more other lower functional elements below the upper functional element, the lower and upper functional elements being able to cooperate together to allow the display of digital information, the lower functional elements extending above the dial, over a smaller area than the area of said upper functional element,
in which said upper functional element has the shape of an annulus or of a segment of an annulus,
the internal dimension of said annulus being at least equal to the external dimension of the visible part of the dial.

Thus, the upper functional element can simulate a bezel or a portion of bezel when the digital display is switched off.

This watch presents in particular the advantage of utilizing the visible part of the digital display by giving it the shape, the color and/or the appearance of a watch bezel or of an annular portion of a watch bezel.

This watch furthermore presents the appearance of a purely analog watch when the digital display is switched off and it merges with the remainder of the bezel or simulation of bezel. This results in a surprise effect when the display is switched on and the user discovers only then that the watch also comprises a digital display.

In contradistinction to conventional digital and analog-digital watches, the digital display is advantageously always on standby, except for a limited duration at the request of the user when the user desires to read the item of information displayed. Thus, the dark patch consisting of the upper surface of the upper functional element is utilized as part of a decorative element when the display is switched off, instead of being constantly occupied by the display.

The realism of the bezel simulation is obtained in particular by virtue of the position of the functional elements of the display above the dial, for example just below the watchglass or even above the watchglass, in the manner of a watch bezel whose upper surface is situated, by definition, above the plane of the dial.

In an example, the upper functional element has an annular shape, or the form of a portion of an annulus, while the other functional elements of the digital display can have a parallelepipedal shape (rectangular viewed from above) etc.

The digital display can thus be produced on the basis of the masks and of the plans of a conventional rectangular display, while replacing solely the upper functional element to give it an annular shape suitable for simulating a bezel around the dial.

The digital display thus produced can be marketed as such so as to be suitable for various movements.

According to one embodiment, the upper functional element extends around the whole of the periphery of the dial.

According to one embodiment, the upper functional element extends around a portion of annulus at the periphery of the dial.

According to one embodiment, the upper functional element extends around the whole of the periphery of the movement.

In a variant, the upper functional element can comprise an upper face which extends directly under the lower face of the watchglass while simulating a bezel. Such a closeness between the digital display and the upper watchglass makes it possible to decrease the parallax effect, to thus improve readability and to protect the upper functional element by the watchglass. The upper functional element is advantageously stationary with respect to the watchglass and with respect to the case.

In another variant, the upper face of the upper functional element can also be above the upper face of the watchglass, so as to improve the bezel simulation.

The case can exhibit an annular peripheral groove, or one in the form of an annular segment, into which is added the upper functional element and forming the housing for the other functional elements of the digital display.

In one embodiment, the upper functional element exhibits through the upper watchglass, a hue identical or similar to that of the remainder of the bezel.

In one embodiment, the upper functional element exhibits through the upper watchglass a hue offering a contrast with respect to the hue of the case and/or of the dial.

When it is switched off, the upper functional element preferably exhibits a dark color; when it is switched on, digital or alphanumeric symbols, or pixels of lighter color appear. Inverted displays making it possible to display symbols as dark on a light background can also be employed.

The upper functional element is preferably stationary with respect to the other functional elements of the display, thereby making it possible to simplify the construction. The upper functional element is preferably stationary with respect to the case. In another embodiment, all the functional elements of the display are mounted on a rotary bezel. The rotation is however not used to render the display visible or invisible. The digital display is arranged so as to become respectively visible and invisible under the control of the electrical display signals alone.

This results in a surprise effect for the user since, a priori when the digital display is switched off, nothing would make it appear that the watch is of the hybrid type. It is only when this display is switched on that the digital display becomes apparent, in a totally unexpected manner, in a bezel portion which does not customarily comprise such a display.

In one embodiment, the digital display is a liquid-crystal display. The upper functional element then consists of an upper polarizer of said digital display.

According to another embodiment, the digital display is a display based on luminous diodes.

The upper functional element then consists of the upper diffuser of said digital display.

In another embodiment, the digital display is an electronic display based on electrophoretic ink (e-ink). The upper functional element then consists of at least one electrode.

The watch in accordance with the invention exhibits advantages with respect to known dual-display watches. Indeed, the upper functional element disposed under a peripheral band of the upper watchglass and around the dial, makes it possible to achieve a virtual bezel, in particular when the digital display is not activated, so that the alphanumeric information is not apparent. No mechanical piece is necessary in order to very realistically simulate the presence of such a bezel.

This watch can be produced at moderate cost by adapting solely the upper functional element of the digital display, for example by replacing the generally rectangular polarizer of a liquid-crystal display by an annular polarizer having the shape and the look of a bezel.

Another advantage stems from the simplicity of assembly. The lower face of the upper watchglass can be added on directly to the upper functional element. No intermediate piece is used. A saving in the thickness of the watch is also obtained.

It is possible to make a digital display comprising one or more rectangular display sectors. A display made in this form is distinctly more economical than an embodiment based on a curved display module, for example a display module all of whose functional elements are annular or circular arc shaped. It is thus possible to use rectangular and standard display sectors, by modifying only the shape and the dimension of the upper functional element. The shape and the dimension of the virtual bezel is thus determined by the upper functional element whereas the other functional elements of the display retain a very economical standard shape. The upper functional element is a relatively inexpensive component of the digital display and can consequently exhibit a complex shape and/or much greater dimensions than those of the other functional means.

The watch in accordance with the invention exhibits the advantage of allowing modular manufacture with various semi-finished products assembled on request.

### BRIEF DESCRIPTION OF THE DRAWINGS

The invention will be better understood on reading the description illustrated by the figures which show:

FIG. 1 is a view from above of an exemplary embodiment of a watch in accordance with the invention, the complementary digital display being switched off or in standby mode.

FIG. 2 is a view from above of an exemplary embodiment of a watch in accordance with the invention, the complementary digital display being switched on so as to display the date.

FIG. 2a is a view from above of an exemplary embodiment of a watch in accordance with the invention, the digital display displaying a brand.

FIG. 2b is a view from above of an exemplary embodiment of a watch in accordance with the invention, the bezel comprising a portion formed by the upper functional element of a display and several non-functional portions.

FIG. 3 is a partial and schematic section through an exemplary watch according to the invention.

FIG. 3a is a partial and schematic section through another exemplary watch according to the invention.

FIG. 4 is a view from above of a second exemplary embodiment of a watch in accordance with the invention, the complementary digital display being switched off or in standby mode.

FIG. 5 is a view from above of a second exemplary embodiment of a watch in accordance with the invention, the complementary digital display being switched on.

FIG. 6 is a partial and schematic section through an exemplary watch according to the invention.

FIG. 7 is a partial section through a digital display according to the invention.

FIG. 7a is a perspective view of a digital display according to the invention.

FIG. 8 is a sectional view of a digital display according to another embodiment of the invention.

FIG. 9 is a view from above of a watch according to the principle of FIG. 8, the complementary digital display being switched off or in standby mode.

FIG. 10 is a view from above of a watch according to the principle of FIG. 8, the complementary digital display being switched on.

### EMBODIMENT(S) OF THE INVENTION

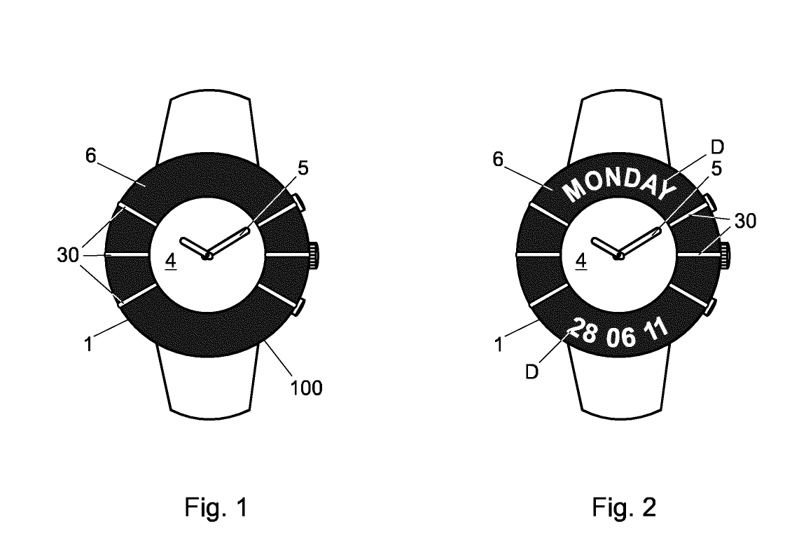

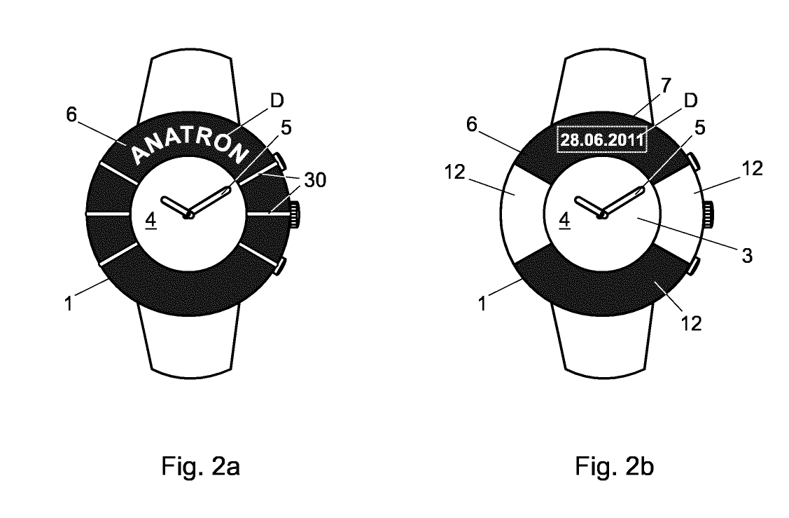

FIGS. 1 and 2 illustrate a watch according to the invention with the display switched off or in standby mode in FIG. 1, and switched on so as to display the date and the day of the week in FIG. 2. In FIG. 2a, the display is used to display a brand. In FIG. 2b, the display for the date is mounted on an annular bezel portion of less than 360°.

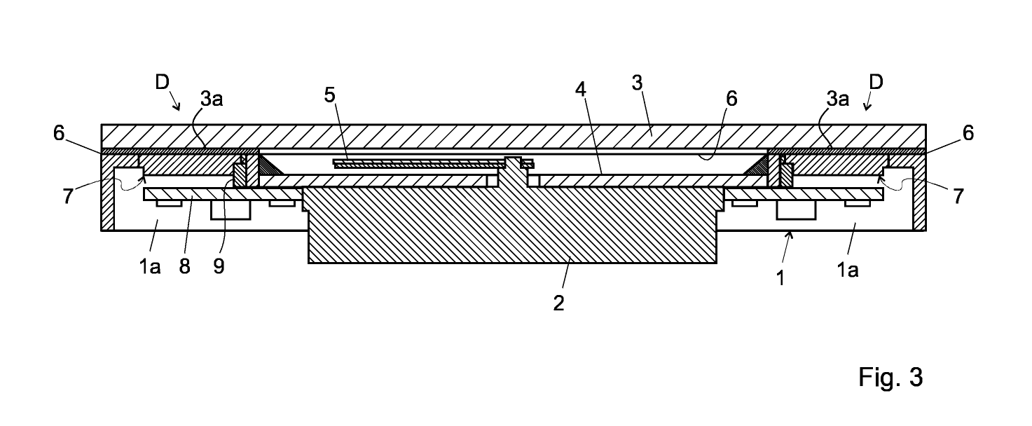

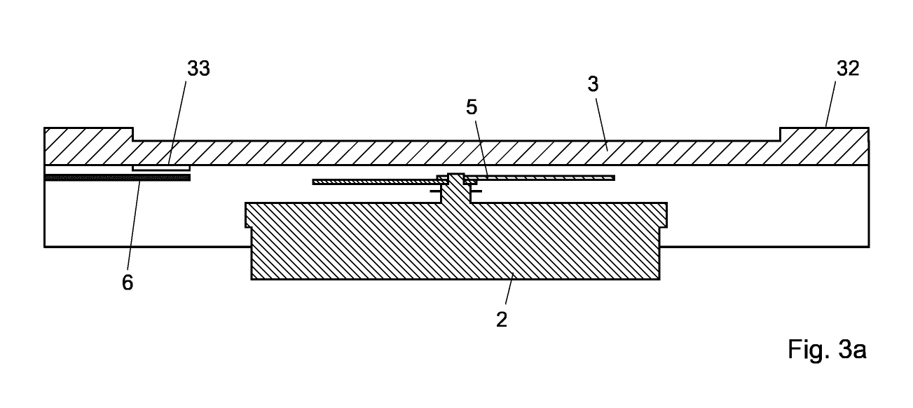

FIG. 3 illustrates a sectional view of the same watch. The watch is equipped with a hybrid dual display with, firstly, hands 5 above a dial 4, and a digital display D in the bezel 6.

The watch comprises in particular a case 100 with a cage 1 and a movement 2 mounted in this cage 1. The movement can for example be a quartz electronic movement, a movement powered by a microgenerator powered by the displacements of an oscillating mass, a mechanical movement comprising an electrical energy source for the digital display, etc.

The watch is furthermore provided with an upper watchglass 3 fixed on the case.

The watch also comprises at least one digital display D for displaying complementary digital information. A means for activating and deactivating the digital display, so as to render the digital display respectively visible when the display is switched on, and invisible when the display is switched off or in standby mode, is also integrated into the watch. This means can comprise for example a push-button, a position of the crown stem, a touch-sensitive watchglass, etc.

The digital display D comprises an upper functional element 6 covering other functional elements 7. The other functional elements 7 collaborate with the upper functional element 6 to form a complete digital display D able to display a visible signal, for example a string of digital or alphanumeric symbols or of pixels.

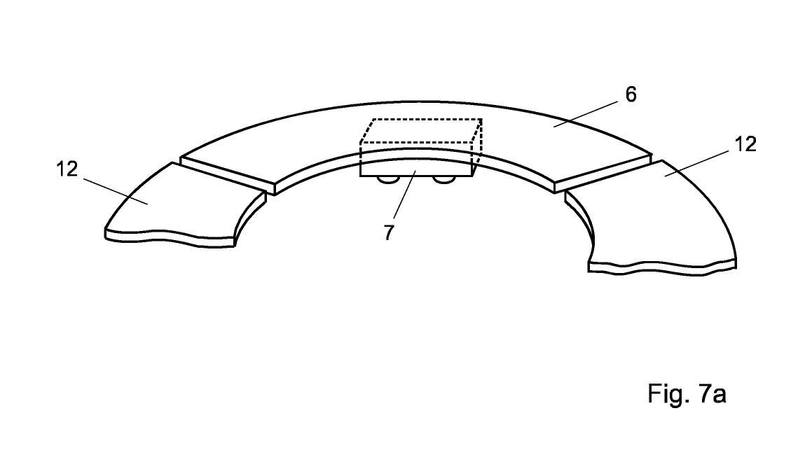

In the embodiment illustrated in FIGS. 1 to 3 and in FIG. 7, the digital display 6-7 is a liquid-crystal display. The upper functional element 6 then consists of an upper polarizer. The other functional elements 7 can comprise a lower polarizer 71 and a liquid-crystal element 70 sandwiched between the two polarizers 6 and 71. Together, the three elements 6, 70 and 71 form, with electrodes and a mirror (neither represented), a functional liquid-crystal display cell, for displaying digital information in the form of segments or in matrix form. In this exemplary embodiment, the watchglass 3 is preferably transparent. The information displayed by the display D is advantageously displayed in the form of bright symbols on a dark background.

According to another embodiment, the digital display is a display based on luminous diodes (LEDS). The upper functional element 6 then consists of an upper diffuser of this digital display. In this exemplary embodiment, the watchglass 3 can locally exhibit particular colorways, for example in the form of depositions by silk-screen printing, so as to improve the display.

According to another exemplary embodiment, the digital display is an electronic display based on electrophoretic ink (E-ink) and the upper functional element 6 consists of at least one transparent electrode. An exemplary embodiment such as this makes it possible to substantially improve the angular extent over which the complementary information can be read. The information is advantageously displayed in white on a black or non-white background, so as to improve the simulation of a bezel when no information is displayed. The information could also be displayed as black on a white background, or in other colors. The electrode forming the upper functional element might not be totally transparent, for example might be tinted. A non-transparent element can be disposed under at least one part of the electrode forming the upper functional element, so as to improve the simulation of a bezel.

According to another exemplary embodiment, the digital display is an electronic display of quantum dot type.

In the examples of FIGS. 1, 2 and 2a, the upper functional element 6 exhibits an annular shape surrounding the dial 4 and the movement 2, hugging the peripheral shape of the watchglass 3. It extends above the plane of the dial, and the internal diameter of the upper functional element is at least equal to the diameter of the dial. In another embodiment, the upper functional element 6 is at least partially superposed above the dial 4 whose periphery it covers; in this instance, the internal diameter of the upper functional element 6 is greater than the visible portion of the dial 4.

As seen in particular in FIG. 3, the upper functional element 6 extends directly under the watchglass 3, more precisely under a peripheral band 3a of the watchglass 3 in such a way as to simulate a bezel at least when the digital display is deactivated or in a standby mode. The upper functional element 6 preferably extends parallel to the peripheral band 3a and directly under said peripheral band 3a, in the form of a circular, rectangular, elliptical, barrel-shaped annulus etc.

The bezel thus simulated renders the digital display D practically invisible when the latter is in standby mode or switched off. The upper functional element 6 is fixed directly under the watchglass 3, well above the dial 4, so that there is no daylight between the upper surface of the display and the watchglass. When a polarizer 6 is involved, this element absorbs the light in all the directions of polarization except one; it therefore has a dark look around the watchglass, which can be enhanced by a dark or non-reflecting surface behind the polarizer, for example by the upper face of the cage 1.

This upper functional element 6 of dark color just under the level of the watchglass 3 therefore makes it possible to simulate a dark bezel at the periphery of the watchglass, the upper surface of the bezel being in this instance level with the upper surface of the watchglass.

In the example of FIG. 3, the upper functional element is clamped directly between the upper watchglass 3 and the cage 1. For this purpose, the cage 1 exhibits a hollow peripheral edge la, onto which is added the upper functional element 6. The hollow peripheral edge la advantageously forms an annular housing or one in the shape of a peripheral annular segment so as to dispose therein in particular the other functional elements 7 of the digital display D.

Decorative elements 30, 31, for example projections, add-on elements, silk-screen-printed portions, synthetic or precious stones, etc. in relief can be provided on the watchglass 3, in particular on the periphery of the watchglass covering the upper functional element 6, so as to improve the simulation of an actual bezel. The bezel can also comprise a scale, for example a tachymeter, town indications for a GMT watch, etc.

In the embodiment of FIG. 3a, the periphery of the watchglass 3 is thicker than the center, so forming an annular lip 32 right around the watch and above the upper functional element 6. This thickening 32 improves the bezel simulation, by giving the impression of a dark colored bezel protruding above the watchglass 3. At least one annular portion of the upper face of this protruding annular portion 32 may be metallized and/or furnished with indices for example.

In FIG. 3a, an annular tracing 33 or one in the form of an annular segment is furthermore glued under the lower surface of the watchglass 3, at the external periphery of the dial 4 and optionally above the upper functional layer 6, in such a way as to show around the dial 4 a scale or indices printed on the tracing. This tracing makes it possible furthermore to conceal the internal edge of the upper functional layer 6.

As may be seen in particular in FIG. 7a, the upper functional element 6 has an annular shape or one in the form of a segment of an annulus, while the other functional elements 7 have a different shape, for example the shape of a substantially rectangular module when viewed from above, and a distinctly smaller area than the area of the upper functional element 6. Thus, it is possible to use a standard and very economical, rectangular display module and to replace the upper functional element by an annular or annulus shaped element.

The other functional elements 7 could also exhibit one or more curved display sectors, substantially hugging the curvature of the upper functional element 6, the curved display sectors 11 being distributed under the upper functional element 6.

In the embodiment of FIG. 2b, the upper functional element 6 has the shape of an annular portion of less than 360° at the periphery of the watchglass 3. The bezel simulation comprises other annular portions 12, forming with the portion 6 an annulus completely surrounding the dial 4 in the manner of a bezel above the plane of the dial. At least one of the portions 12 has substantially the same color as the upper functional element 6 when the display is switched off; other portions 12 may have a different color. In a variant, not illustrated, all the portions 12 have the same color as the upper functional element 6 when the display is switched off, so as to simulate a dark bezel around the dial when the display is switched off. Thus, the color of at least one portion 12, of the portion of upper functional element 6 in front of the lower functional elements 7, and of the portion of upper functional element 6 in front of the cage 1 and alongside the lower functional elements 7, is substantially identical, giving the impression when the display is switched off that all these portions constitute various segments of one and the same bezel.

The second annular portion 12 may be formed for example of metal, of ceramic or of crystal. In one embodiment, the second annular portion is formed by a metallized portion of the lower surface of the watchglass 3.

Only a limited portion of the upper functional element 6 can therefore be used for the display of digital information. In one embodiment, several other functional elements are disposed in various locations under a single upper functional element 6, or under various upper functional elements in the form of annular segments, for example at 6 o'clock and at 12 o'clock as in FIG. 2. By way of example, one or more rectangular display sectors may thus be distributed under an upper functional element of annular shape. The other functional elements 7 then exhibit several rectangular display sectors distributed under a virtual bezel made by the upper functional element 6.

The cage 1 is for example made from a metallic material and the upper functional element 6 advantageously exhibits through the watchglass 3, a hue identical or similar to that of the cage 1. In particular, the upper part of the cage 1 on which the upper functional element 6 rests preferably has a look, as seen through the polarizer filter 6, that is as close as possible to the look of the other functional elements 7 of the switched-off digital display D, in such a way that the transition between this cage 1 and the portion of the polarizer in front of the display D is as little visible as possible.

According to an advantageous exemplary embodiment of the watch, the dial 4 is a metallic dial, which may for example be silk-screen-printed, guilloché, or furnished with any appropriate decoration or coating. The cage 1 may also be made from a metallic material.

The cage 1 also comprises a printed circuit 8 disposed in a space delimited by the edge la, thus constituting a housing for the electrical and electronic units. Electrical contacts 9 linking the printed circuit 8 to the means for generating an optical signal 7 are also provided.

An electric battery powering the digital display D and the movement 2 is advantageously integrated into the cage 1. This electric battery may be associated with another energy source, electrical or mechanical, powering the movement 2.

According to an exemplary embodiment not illustrated, the watchglass 3 is cambered so as to exhibit a peripheral band 3a whose inclination facilitates the readability of the digital information displayed. The upper functional element 6 and the display sector or sectors may then exhibit the same inclination as the peripheral band 3a.

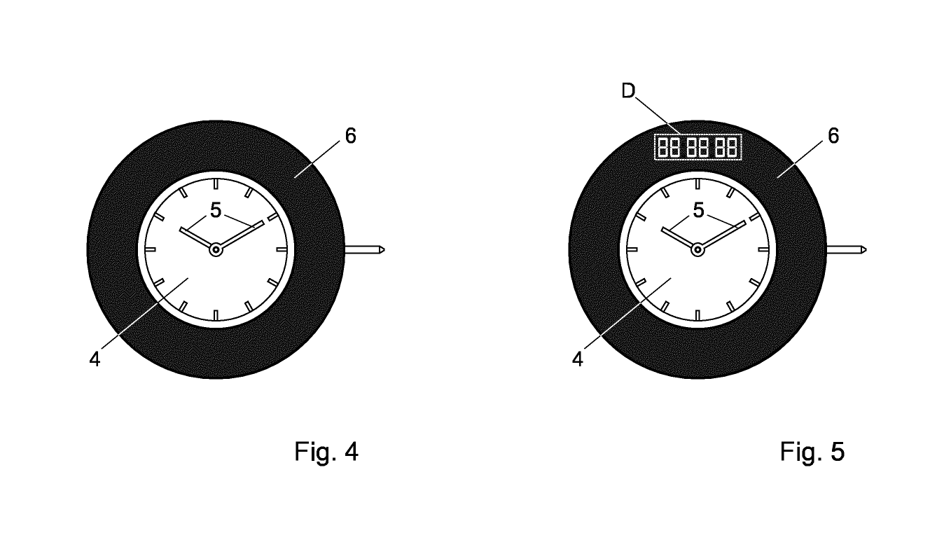

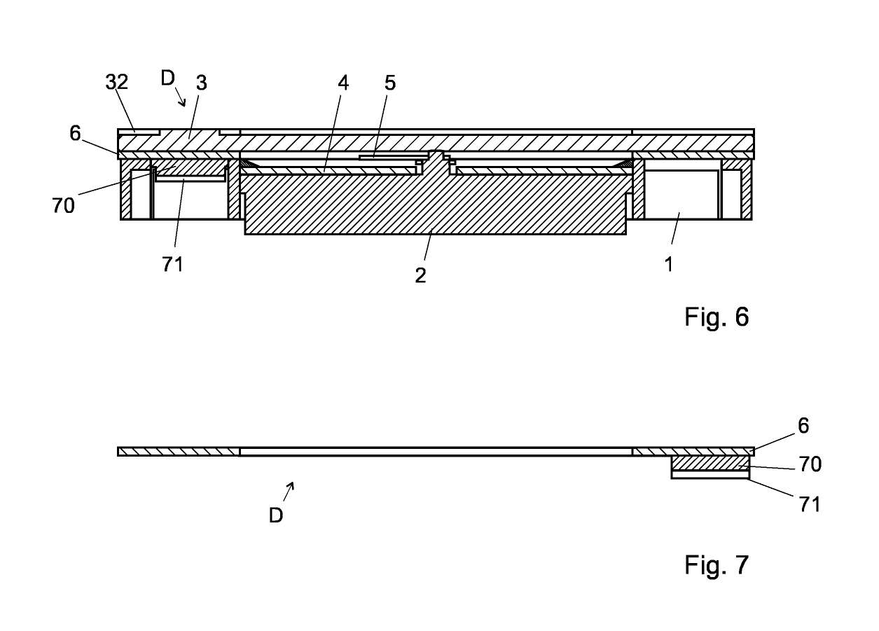

FIGS. 4 and 5 are views from above of another exemplary embodiment of a watch in accordance with the invention, with various states of activation of a complementary display function. FIG. 6 shows a sectional view of this watch. With respect to FIG. 3, it furthermore comprises a metallized portion 32 under the periphery of the watchglass 3, above the virtual bezel 6, so as to improve the simulation of an actual bezel. In another embodiment not illustrated, the peripheral portion of the watchglass above the upper active element 6 is covered with a bezel or with a metallization comprising one or more windows above the digital display or displays D. It is also possible to directly cover the upper active element 6 with a bezel or with a metallized portion, without intermediate watchglass. The bezel or the metallized portion advantageously has the same color as the digital display in OFF mode, so as to render this display almost invisible when it is not used.

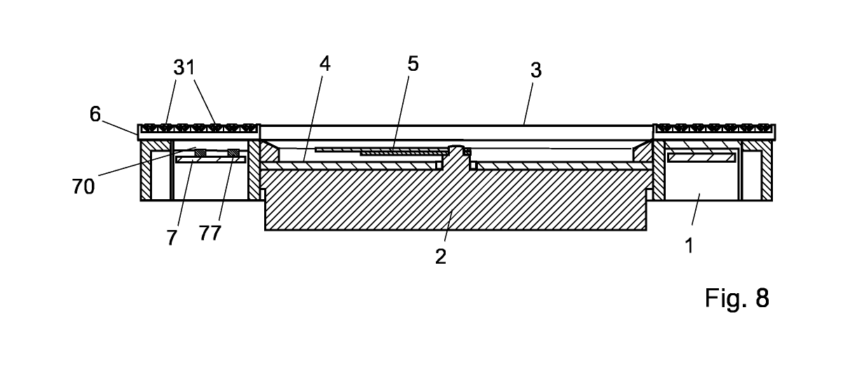

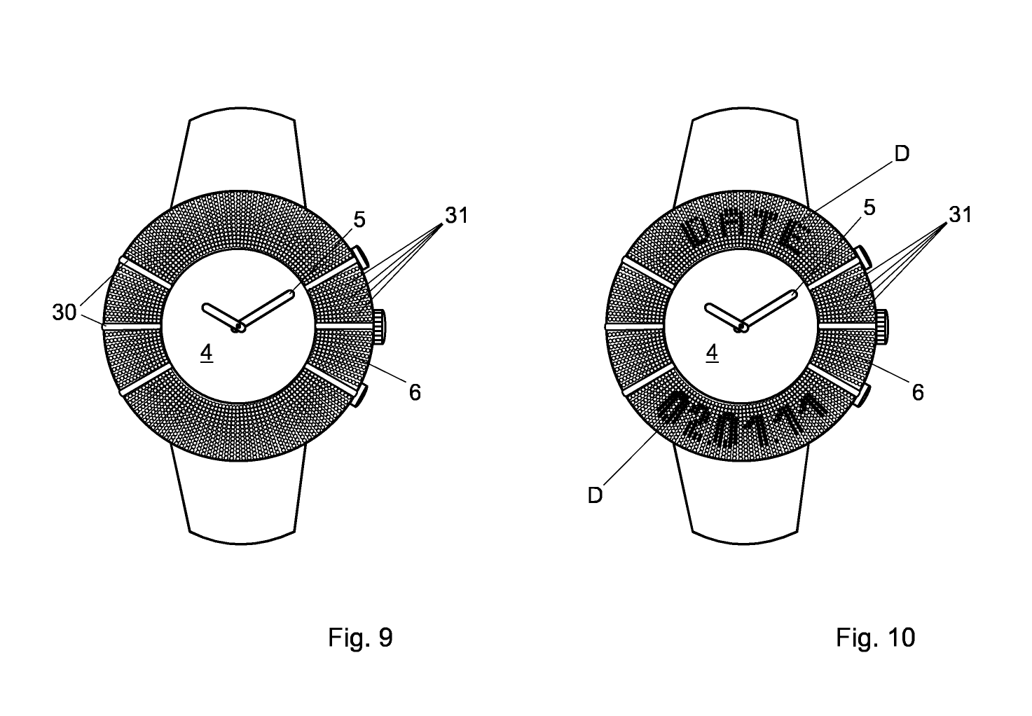

Decorative elements 30, 31, 32 may also be disposed directly above the upper functional element and the display portion D. In the example illustrated in FIGS. 8 to 10, it is possible to crimp above each pixel or segment of these other display means one or more stones 31 which light up when the digital display is switched on. A luminous diode is then situated behind each stone intended to operate as a pixel of the display. This solution is particularly advantageous when a display D based on LEDs 77 is involved, each LED then illuminating a stone on the virtual bezel. The stones 31 can be crimped, glued, embedded in a synthetic support 6, or fixed by overmolding a support under the stones. In an advantageous embodiment, the stones are fixed in blind holes by means of claws or rails molded in a stone support made of transparent material, for example in a peripheral portion of the watchglass above the upper functional element 6.

The bezel 6 is preferably stationary with respect to the other functional elements 7 of the digital display D. There is therefore no reason to provide for particular leaktightness and the other functional elements can simply be glued under the upper functional element 6. The bezel 6 is preferably also stationary with respect to the cage 1, to the movement and to the case 100, thereby simplifying the mechanical construction. It is however also possible to provide for a rotating bezel that revolves with respect to the case; in this instance, the digital display D and the other functional elements 7 advantageously revolve with the bezel.

1. A watch comprising:
a case (1),
a movement (2) mounted in said case,
a watchglass (3),
a dial (4);
hands (5), at least one digital display (D) comprising an upper functional element (6) and one or more other lower functional elements (7) below the upper functional element, the lower functional elements and upper functional element being able to cooperate together to allow the display of digital information, the lower functional elements extending above the dial, over a smaller area than the area of the upper functional element (6), characterized in that said upper functional element (6) has the shape of an annulus or of a segment of an annulus, in that the internal dimension of said annulus is at least equal to the external dimension of the visible part of the dial (4), in such a way that said upper functional element (6) simulates a bezel or a portion of bezel when said digital display is switched off.

2. The watch as claimed in claim 1, characterized in that the upper functional element (6) extends over an annular surface, and in that said other functional elements (7) extend over a substantially rectangular surface which is smaller than said annular surface.

3. The watch as claimed in claim 2, characterized in that said annular surface (6) possesses at the internal diameter greater than or equal to 50% of the external diameter.

4. The watch as claimed in claim 1, characterized in that the dial is circular, and in that the internal diameter of the upper functional element (6) is at least equal to the external diameter of the dial (4).

5. The watch as claimed in claim 1, characterized in that the upper functional element (6) extends around the whole of the periphery of the dial (4).

6. The watch as claimed in claim 1, characterized by a bezel or simulation of bezel of which a first annular portion (6) consists of said upper functional element, and of which a second annular portion (12) has substantially the same color as said upper functional element when said digital display is switched off.

7. The watch as claimed in claim 6, said second annular portion (12) having a dark color identical to the color of said upper functional element when the display is switched off.

8. The watch as claimed in claim 6, said second annular portion being formed of metal, ceramic or crystal.

9. The watch as claimed in claim 6, said second annular portion being formed by a metallized portion of the lower surface of the watchglass.

10. The watch as claimed in claim 1, characterized in that the upper surface of said upper functional element (6) is situated immediately under the lower surface of the periphery of the watchglass (3).

11. The watch as claimed in claim 1, characterized in that the upper surface of said upper functional element (6) is above the upper surface of the watchglass (3).

12. The watch as claimed in claim 1, characterized in that the upper surface of the watchglass (3) exhibits an annular lip (33) above said upper functional element (6).

13. The watch as claimed in claim 1, characterized by a tracing of annular shape or in the form of an annular segment under the watchglass (3) at the external periphery of the dial (4).

14. The watch as claimed in claim 1, characterized in that said upper functional element is stationary with respect to the other functional elements.

15. The watch as claimed in claim 1, characterized in that said upper functional element is stationary with respect to said case.

16. The watch as claimed in claim 1, characterized in that the digital display (D) is a liquid-crystal display, the upper functional element (6) consisting of the upper polarizer of said display.

17. The watch as claimed in claim 1, characterized in that the digital display is a display with luminous diodes (77), the upper functional element (6) consisting of the upper diffuser of said display.

18. The watch as claimed in claim 1, characterized in that the digital display is an electronic display with electrophoretic ink, the upper functional element (6) consisting of at least one transparent electrode.

19. The watch as claimed in claim 1, characterized in that the digital display is an electronic display of quantum dot type.

20. The watch as claimed in claim 1, comprising one or more decorative elements (30) in the form of metallized or printed portions in relief of the watchglass (3) covering said digital display.

21. The watch as claimed in claim 20, said decorative element or elements (30) comprising some stones.

22. The watch as claimed in claim 21, said digital display being a display with light-emitting diodes (77), said decorative element or elements comprising stones (31) above said light-emitting diodes and illuminated by said light-emitting diodes.
